(19) United States
(12) Patent Application Publication
(10) Pub. No.: US 2005/0191134 A1
(43) Pub. Date: Sep. 1, 2005

(54) Telescoping underwater guide

(76) Inventor: Richard Coppola, Langhorne, PA (US)

Correspondence Address: RICHARD COPPOLA, PO Box 99, LANGHORNE, PA, 19047, US

(21) Appl. No.: 11/050,976

(22) Filed: Feb. 4, 2005

Related U.S. Application Data
(60) Provisional application No. 60/547,442, filed on Feb. 26, 2004.

(51) Int. Cl. E03B 7/10; F16L 57/00

(52) U.S. Cl. 405/157; 405/158

(57) ABSTRACT

The invention is an underwater guiding apparatus being a sectional and telescoping assembly of two or more segments where one or more segments are static and one or more segments are movable permitting the extension and retraction of the assembly varying its length by extending and retracting the telescoping assembly. The assembly has a base for anchoring the guide to a fixed or variable elevation work surface with fixed or dynamic control with one or more binding blocks with set screws and pins. The guide can self adjust its angle of installation. The guide is a method for guiding underwater submerged elongated structures through varying water column depths

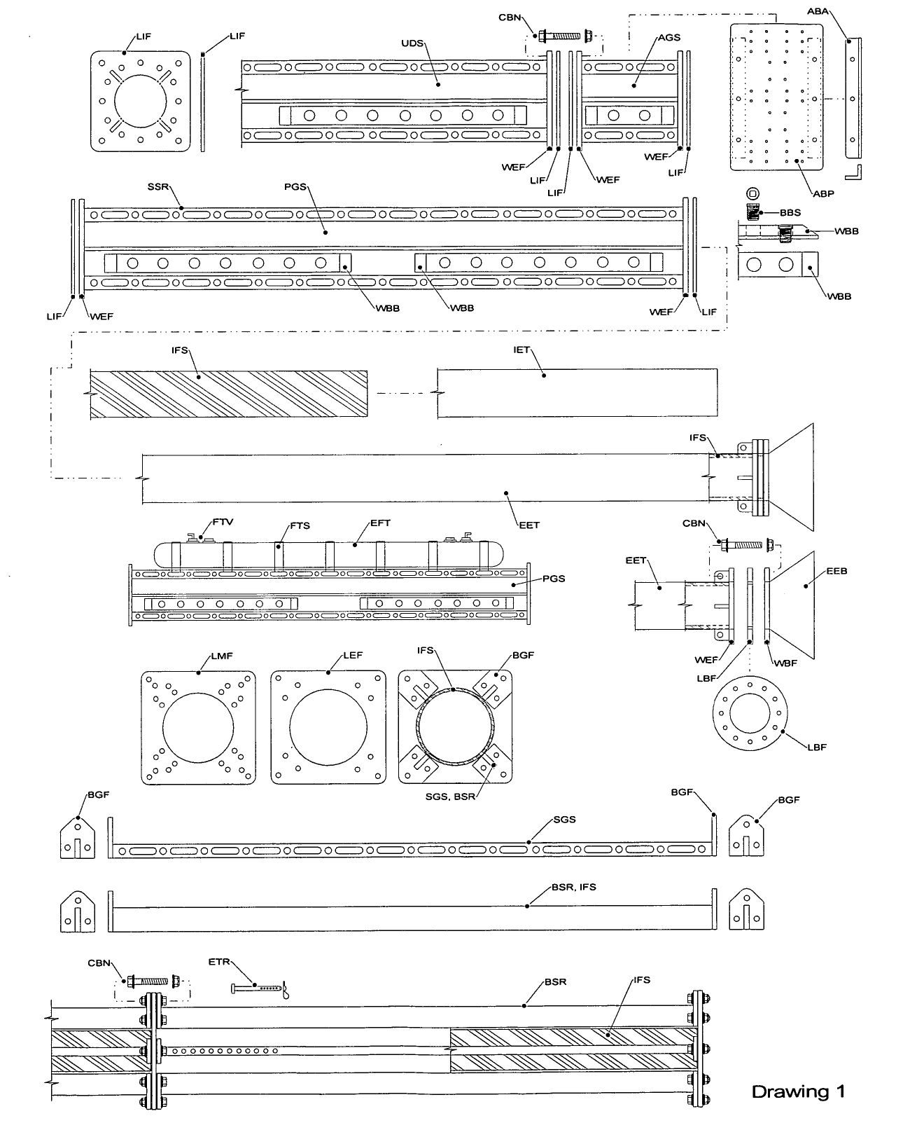

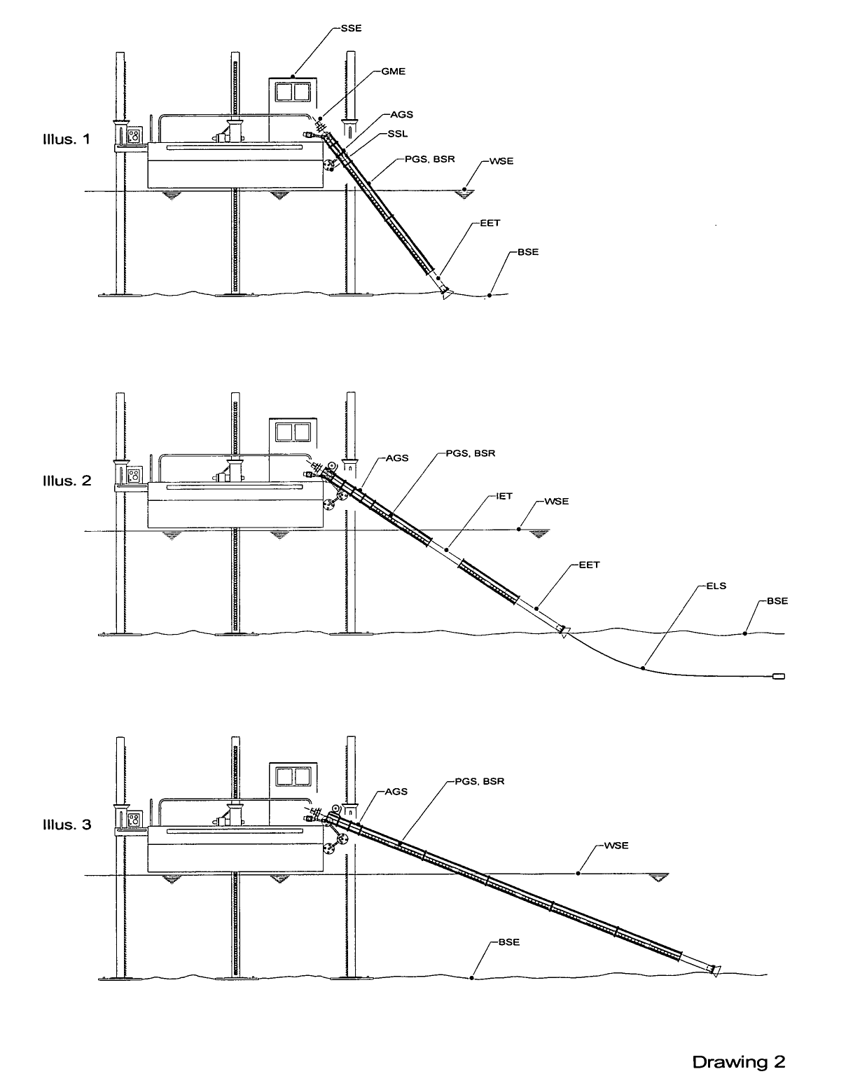

### FIELD OF THE INVENTION

The present invention relates to a sectional and telescoping device for guiding elongated objects such as directional, variable angle drill, bore and such machine and other stems, rods, piping, tubing, hoses, cables, lines and other similar elongated structures being semi-submerged, and/or completely submerged underwater operating through variable water column depths in lakes, streams, rivers, coastal waters, oceans and into and through waterway bottom and other materials without environmental impact.

More specifically, it relates to a means for guiding directional, variable angle drill, bore, and such machine, equipment and material stems, rods, piping, tubing, hoses, cables, lines and other similar structures underwater through varying water column depths at variable angles by creating an infinitely adjustable segmented and telescoping, dynamic and lockable telescoping guide thereby infinitely adjusting in static, dynamic and hybrid functions to the distance between fixed, variable elevation, floating work surfaces, and surface machinery, equipment and materials and the waterway bottom and other materials. Its installation and operational angle is infinitely adjustable. Its integrated floatation and buoyancy in water is infinitely adjustable per segment or over its entire length. Its structural width is adjustable per segment or over its entire length thereby permitting the handling and installation of various dimension drill, bore, machine, stems, rods, piping, tubing, hoses, cables, lines and other similar structures in semi-submerged and submerged underwater applications into and through waterway bottom and other materials without environmental impact.

### BACKGROUND OF INVENTION

Variable angle bore, drill stems and other type pipe, rod and elongated objects are limited and prevented from penetration and installation through various water columns into and through waterway and other bed materials due to absence of a segmented and Telescoping Underwater Guide providing infinitely adjustable dynamic and static longitudinal adjustment functions and operation while providing variable structural width and lateral support for bore, drills, stems rods, piping, tubing, hoses, cables, lines and other elongated objects and similar structures in semi-submerged and submerged underwater applications and absence of adjustability to accommodate varying water column depths between the water surface and waterway bottom and other material elevation(s), as well as other clear dimensional applications and absence of the ability to sectionally and telescopically adjust the guide length statically, dynamically and in hybrid mode in single, and multi-sectional length, sectional width, and its angle to the waterway bed and other material elevations and absence of a system and method of handling and installing various dimension drill, bore, machine, stems, rods, piping, tubing, hoses, cables, lines and other similar structures in semi-submerged and submerged underwater applications while eliminating environmental impact. For these reasons, there is a need in the art for a new system to permit penetrations through varying water column depths, into and through waterway bed and other materials at various angles in submerged, semi-submerged and other applications which overcomes the above disadvantages and limitations described.

### SUMMARY OF INVENTION

The invention is and underwater guiding apparatus comprising a telescoping assembly of two or more tubing segments wherein one or more tubing segments are static and one or more tubing segments are movable and of a different diameter than the static segments with a means for coupling the tubing segments wherein said means permits the extension and retraction of the telescoping assembly and a means for varying the length of underwater guiding apparatus by extending and retracting the telescoping assembly.

The underwater guiding apparatus comprises a means for locking the telescoping assembly in a fixed length configuration and further comprises a means for adjusting the angle of the telescoping assembly. The underwater guiding apparatus comprises a base for anchoring the underwater guiding apparatus to a fixed or variable elevation work surface. The underwater guiding apparatus comprises a telescoping assembly wherein the telescoping assembly comprises an outer receiver pipe, an inner extension pipe, and a cone end, wherein the inner extension pipe is slidably engaged with the outer receiver pipe to permit extension and retraction of the inner extension pipe, and the cone end is secured to the end of the inner extension pipe. The underwater guiding apparatus further comprises a winch to assist for extention and retraction the inner extension pipe.

The underwater guiding apparatus further comprises a base plate secured to the telescoping assembly for anchoring the underwater guiding apparatus to a fixed or variable elevation work surface. The underwater guiding apparatus wherein the telescoping assembly further comprises a base receiver segment coupled to the outer receiver pipe of the telescoping assembly.

The underwater guiding apparatus wherein the telescoping assembly further comprises one or more binding blocks with set screws and pins for locking the inner extension pipe in a fixed position.

The underwater guiding apparatus wherein the telescoping assembly further comprises one or more additional inner extension pipes of differing diameters of the first extension pipe positioned between the outer receiver pipe and the cone end to permit increased extension length.

The underwater guiding apparatus wherein the cone end is secured to the telescoping assembly by being bolted or welded on to the inner extension pipe and further comprises a means for adjusting the angle of the telescoping assembly wherein a means for adjusting the angle of the telescoping assembly is a winch.

The underwater guiding apparatus wherein one or more of the pipes of the telescoping assembly are comprised of a plurality of bars in a substantially cylindrical pattern and a friction sleeve positioned within and secured by the bars. The underwater guiding apparatus bars are constructed containing airtight cavities thereby enabling the pipe to function as a floatation vessel. The underwater guiding apparatus wherein one or more of the components of the telescoping assembly further comprise integrated flotation vessels.

The underwater guiding apparatus is a method for guiding underwater submerged elongated structures through varying water column depths comprising the steps of: positioning the underwater guiding apparatus in the area of the elongated structure to be guided and orienting the telescoping assembly to the desired angle and extension length.

The method for guiding underwater submerged elongated structures wherein the elongated structure is one of stems, rods, piping, tubing, hoses, cables, and lines. The method for guiding underwater submerged elongated structures wherein the guiding is performed for the placement and installation of the elongated structures. The method for guiding underwater submerged elongated structures further comprises the step of securing the base and assembly to a fixed or variable elevation work surface.

### BRIEF DESCRIPTION OF THE DRAWINGS

Drawing number 1 is a general illustration matrix of the sectional telescoping underwater guide with its basic component types identified accordingly. Adaptations and variations to the component types not shown are within the scope of development and operation of the invention. FIG. PGS is a profile view of a primary guide section providing structural and lateral support for the inner-friction sleeve and elongated structures placed within the PGS and inner-friction sleeve. FIG. SSR is a profile view of a PGS deflection support rail. The SSR as shown is weld mounted, drilled and slotted to provide infinite connection points along individual and multiple PGS lengths. FIG. WBB is a plan view of the binding block used to control the dynamic activity and/or static position of the inner extension tube. FIG. BBS is a profile view of binding block dynamic friction and lock down screws threading through the WBB and PGS permitting infinite control the dynamic activity and/or static position of inner extension segments and end extension segment. FIG. IET is a profile view of an intermediate PGS inner-extension tube used for dynamic and static extension of multiple PGS segments. FIG. AGS is a profile view of an auxiliary guide section which is typically shorter in length than the PGS section. The AGS sections are used individually or in multiple assemblies at the ends or anywhere between the PGS sections functioning as a connection point or linkage to support equipment, support accessories and to control the dynamic activity and/or static position of inner extension segments and/or end extension segment. FIG. ABP is a plan view of an accessory base plate either directly mounted to and between the flange ends of the AGS or by using mounting bracket angles. FIG. WEF is a profile view of the AGS mounting bracket angles. FIG. LIF are profile and plan views of an intermediate IFS and IET control flange for segmental containment or multi-segment transition of IFS components. LIF flanges when used are typically installed between WEF components using connecting hardware. FIG. CGN is a profile view of typical type WEF and LIF connection hardware. FIG. EFT is a profile view of the external floatation tube for water surface assembly of PGS and other segments of the sectional telescoping underwater guide. FIG. FTS is a profile view of the EFT connecting straps to SSR component slots. FIG. FTV is a profile view of EFT inflation and deflation valves for pneumatic control of EFT components for assembly, deployment and recovery of independent and/or multiple PGS components. FIG. EET is a profile view of an inner-end extension segment used for dynamic telescoping and/or static functions. FIG. WEF is a profile view of the welded end flange attached to the EET. FIG. EEB is a profile view of the inner-end segment extension bell attached to the WEF for docking of elongated structures. FIG. LBF are profile and plan views of loose bell flanges installed as a control flange for segmental extension end containment or multi-segment transition of IFS components. LBF flanges when used are typically installed between WEF and WBF components using CBN connecting hardware. FIG. IFS is a profile view of the inner-friction sleeve typically inserted within PGS, EET, AGS, SGS and BSR components functioning as a friction sleeve, wear surface, and bearing. FIG. SGS is a profile view of the slotted guide section functioning as structural and lateral support for the inner-friction sleeve and elongated structures placed within the IFS. FIG. BGF are profile and plan views of end flanges attached to the ends of SGS components and LEF or LMF flanges using CBN connecting hardware. In this configuration individual SGS rails can be disconnected. FIG. SGS is a profile view of the slotted guide section functioning as structural and lateral support for the inner-friction sleeve and elongated structures placed within the IFS. FIG. BGR is a profile view of the boxed guide rail functioning as structural and lateral support for IFS inner-friction sleeves and elongated structures placed within the IFS. Inner EET and IFS components are controlled by BBS and/or ETR components. BGR rails also function as integrated containment vessels for pneumatic control, assembly, deployment and recovery of independent and/or multiple guide components. SGS and BGR components can be interchanged and/or mixed. FIG. LEF is a plan view of an end flange which is bolted to the BGF flanges. FIG. LMF is a plan view of an end flange with multiple BGR mounting positions permitting use of variable size IFS components.

Drawing number 2 is a general illustration matrix of the sectional telescoping underwater guide deployed in a variety of configurations, angles and lengths. Adaptations and variations in assembly not shown are within the scope of development and operation of the invention. Illustration 1 is a profile view of one type of surface support equipment identified as FIG. SSE and the telescoping underwater guide components identified as PGS/BSR. The illustration shows a configuration using two PGS/BSR segments, three AGS segments and one EET segment. FIG. BSE is a profile view of the waterway bed elevation. This illustration shows the telescoping underwater guide positioned at a 55 degree angle extending 34′ in length with 16′ lateral reach. Illustration number 2 is a profile view of one type of surface support equipment identified as FIG. SSE (ref. illus. 1) and the telescoping underwater guide components identified as PGS/BSR. The illustration shows a configuration using two PGS/BSR segments, one IET segment, four AGS segments and one EET segment. FIG. BSE is a profile view of the waterway bed elevation. This illustration shows the telescoping underwater guide positioned at a 35 degree angle extending 44′ in length with 40′ lateral reach. FIG. ELS is a profile view of a typical longitudinal position of elongated structures used with the underwater telescoping guide. Illustration number 3 is a profile view of one type of surface support equipment identified as FIG. SSE (ref. illus. 1) and the telescoping underwater guide components identified as PGS/BSR. The illustration shows a configuration using five PGS/BSR segments, three AGS segments and one EET segment. FIG. BSE is a profile view of the waterway bed elevation. This illustration shows the telescoping underwater guide positioned at a 20 degree angle extending 72′ in length with 60′ lateral reach. Illustrations one, two and three show FIG. EET in dynamic and static function modes.

### EXPLANATION OF THE INVENTION

In order to eliminate prior restrictions and limitations, the present invention has been devised for guiding, orienting, directing and installing elongated structures such as directional and variable angle machine, bore, drill, equipment, materials, stems, rods, piping, tubing, hoses, cables, lines and other elongated structures being semi-submerged and/or fully submerged underwater through varying water column depths in lakes, streams, rivers, coastal waters, oceans and through waterway bottom and other materials. The present invention has been devised as a means for guiding and installing directional, variable angle drill, bore, and such machine, equipment and material stems, rods, piping, tubing, hoses, cables, lines and other elongated structures being semi-submerged and/or fully submerged underwater through varying water column depths at variable angles by creating an infinitely adjustable segmented and telescoping, dynamic and lockable telescoping guide thereby infinitely adjusting in static, dynamic and hybrid functions to the distance between fixed, variable elevation, floating work surfaces, and surface machinery, equipment and materials into and through the waterway bottom and other materials. Its installation and operational angle is infinitely adjustable. Its integrated floatation and buoyancy in water is infinitely adjustable per segment or over its entire length. Its structural width is adjustable per segment or over its entire length thereby permitting the handling and installation of various dimension drill, bore, machine, stems, rods, piping, tubing, hoses, cables, lines and other similar structures in semi-submerged and submerged underwater applications without environmental impact.

Referring now to Drawing number one, illustrating the primary components of the underwater telescoping guide assembled to permit a longitudinally variable length, angle, dynamic extension, static length, and laterally rigid underwater guide for elongated structures including but not limited to directional/variable angle drill and machine stems, rods, piping, tubing, hoses, cables, lines and other similar longitudinal structures underwater and through the water column to waterway bed materials.

Referring now to Drawing number two, The telescoping underwater guide is shown mounted to a fixed elevation work surface located above the water surface elevation. The invention can be mounted to any fixed elevation work surface as shown, floating work surface, semi-submerged, fully submerged or suspended above or below the water surface the Telescoping Underwater Guide is shown in a variety of extended and retracted positions in dynamic and static function. Also shown is an end extension bell for machine, equipment and material installation docking, and recovery. A flange with a connection point is used to secure the extension bell end to the primary telescoping underwater guide components and to operate the guide assembly by hand or winch for extension and retraction of the end extension segment as well as guide component and support equipment handling and operation.

The above-described invention provides for guiding, direction, penetration, placement, and installation, of elongated structures such as directional, variable angle machine, bore, drill, equipment, material and such elongated structures such as stems, rods, piping, tubing, hoses, cables, lines and other similar structures submerged underwater, semi-submerged through varying water column depths and at variable angles by creating an infinitely adjustable angle, length, diameter, width, dynamic, and statically controlled sectional, telescoping and hybrid operational guide thereby adjusting to the distance between fixed, variable elevation, or floating work surface elevations interfacing with surface machinery, equipment, materials into and through waterway and other bed materials in semi-submerged, underwater and other applications with the following distinct features and advantages.

1. It provides for guiding, direction, penetration, placement, and installation, of elongated structures such as directional, variable angle machine, bore, drill, equipment, material and such elongated structures such as stems, rods, piping, tubing, hoses, cables, lines and other similar structures submerged underwater, semi-submerged through varying water column depths and at variable angles by creating an infinitely adjustable angle, length, diameter, width, dynamic, and statically controlled sectional and telescoping guide thereby adjusting to the distance between fixed, variable elevation, or floating work surface elevations and surfaces interfacing with surface machinery, equipment, materials into and through waterway and other bed materials in fully submerged, semi-submerged and above water applications

2. It is infinitely adjustable in length. It can be adjusted to any length within its operational limits for various submerged, semi-submerged water column or above water clear dimensions encountered.

3. It is infinitely adjustable in orientation and angle of installation. It can be adjusted to any angle within its operational limits for various submerged, semi-submerged water column or above water clear dimensions encountered.

4. It can be incrementally sized in overall diameter and width to accommodate a variety of elongated structures and inner guide components for various directional, variable angle machine, bore, drill, stems, rods, piping, tubing, hoses, cables, lines equipment, materials and other such elongated structures.

5. It permits variable configuration of both external and internal guide components such as tubes, brackets, rails, frames, clamps, through hole plates, trusses, and standoffs.

6. It permits variable configuration of the guide support rails such as number and configuration of rails used along with a variety of rail materials such as solid, angular, box, and tubular materials which can be drilled, slotted, and machined to accommodate various features, options, equipment, capabilities and attachment points.

7. It permits independent and combined sectional and telescoping guide configuration using solid wall tubing, drilled or slotted tubing, rings, beams, support rails, trusses, frames and angular or box materials.

8. It permits variable configuration of telescoping lock and extension and retraction travel mechanisms such as dynamic friction and static lock down screws, pressure screws, travel limitation screws, springs, bolts, pins, and linkage.

9. It permits variable mounting and attachment of extension end segments and bell end section such as bolting, sliding, clamping, clipping, machine fitting or being fixed as well as variable bell configurations in angle, length, diameter, curved, solid wall, slotted, banded, caged, rigid or flexible.

10. Once installed, it can function statically thereby fixing its overall length.

11. Once installed, it can function dynamically thereby self adjusting its length for varying water column depths and changes in end to end clear dimension due to wave action, tides, changes in work surface elevation, external mechanical, natural forces and other factors.

12. Once installed, it can function statically and dynamically thereby partially and sectionally fixing its overall length while partially and sectionally self adjusting its length for varying water column depths and changes in end to end clear dimension due to wave action, tides, changes in work surface elevation, external mechanical, natural forces and other factors.

13. It is self deploying. Attaching support equipment to auxiliary base plate(s) such as a winch or other type equipment assists in mobilization, setup, deployment, extension, retraction, recovery, breakdown, demobilization, and storage of the guide components as well as support equipment and handling, manipulation and recovery of elongated structures.

14. Each guide section is rigid thereby reducing overall deflection using single or multiple guide segments.

15. It can be manufactured from a variety of materials such as aluminum, steel, alloys, composites, and plastics.

16. It can be universally mounted to a variety of construction, mechanical and scientific type equipment.

17. It can be used from fixed or adjustable elevation work surfaces, floating work surfaces or from suspended structures.

18. It is adjustable and expandable in length, diameter, width and operational capabilities by adding additional guide segments and components to increase its scope and range of operation.

19. It is simple. It has no moving parts in static configuration and one moving part in dynamic configuration.

20. It is portable. Each guide segment can be sized in length and width and can be completely or partially collapsed or dismantled, and easily transported in a small vehicle.

21. It is light weight. Each of its component segments and components can be lifted and transported by hand.

22. The present invention provides a professional and aesthetic appearance with functional performance. The drilled and slotted support rails and beams reduce overall deflection, reduce weight and provide numerous connection points along their full length. The external box support rails provide lateral support for the inner guide components while providing internal integrated floatation control for individual and multiple guide segments.

23. Underwater telescoping Guide components can be easily assembled, used and dissembled in-water at the water surface using the external floatation tubes secured to the guide support rails providing external integrated floatation control for individual and multiple guide segments.

24. The end extension segment bell cone assists in self alignment, docking and recovery of installed elongated structures.

25. The integrated floatation system permits simple sectional guide assembly at the water surface while providing infinite operational floatation and buoyancy adjustment and control for individual and multiple segments.

26. The present invention permits orientation, placement and installation of elongated structures through the water surface, water column and into and through waterway bed and other materials with no environmental impact.

27. The above advantages and uses may be employed in any area of application limited only by the imagination of the user. For example, in underwater applications, the method of the present invention may be employed for the following environments and applications.

1. Underwater.

2. Semi-submerged.

3. Above water.

4. Installation of power and other cables and lines.

5. Installation of fiber optic and other type communications cables.

6. Installation of utility and other lines and conduits.

7. Installation of pipelines.

8. Installation of navigation lighting and related systems.

9. Installation of anchoring cables and similar structures.

10. Bottom and sub-bottom material sampling.

11. Probing.

12. Remote testing.

13. Installation of sub-bottom sensors.

14. Installation of sub-bottom instrumentation.

1. An underwater guiding apparatus comprising:
a. a telescoping assembly of two or more tubing segments wherein one or more tubing segments are static and one or more tubing segments are movable and of a different diameter than the static segments;
b. a means for coupling the tubing segments wherein said means permits the extension and retraction of the telescoping assembly; and
c. a means for varying the length of underwater guiding apparatus by extending and retracting the telescoping assembly.

2. The underwater guiding apparatus of claim 1 further comprising a means for locking the telescoping assembly in a fixed length configuration.

3. The underwater guiding apparatus of claim 2 further comprising a means for adjusting the angle of the telescoping assembly.

4. The underwater guiding apparatus of claim 3 further comprising a base for anchoring the underwater guiding apparatus to a fixed or variable elevation work surface.

5. A underwater guiding apparatus comprising:
a telescoping assembly; wherein the telescoping assembly comprises an outer receiver pipe, an inner extension pipe, and a cone end, wherein the inner extension pipe is slidably engaged with the outer receiver pipe to permit extension and retraction of the inner extension pipe, and the cone end is secured to the end of the inner extension pipe.

6. The underwater guiding apparatus further comprising a winch for extending and retracting the inner extension pipe.

7. The underwater guiding apparatus of claim 5 further comprising a base plate secured to the telescoping assembly for anchoring the underwater guiding apparatus to a fixed or variable elevation work surface.

8. The underwater guiding apparatus of claim 5 wherein the telescoping assembly further comprises a base receiver segment coupled to the outer receiver pipe of the telescoping assembly.

9. The underwater guiding apparatus of claim 8 wherein the telescoping assembly further comprises one or more binding blocks with set screws for locking the inner extension pipe in a fixed position.

10. The underwater guiding apparatus of claim 5 wherein the telescoping assembly further comprises one or more additional inner extension pipes of differing diameters of the first extension pipe positioned between the outer receiver pipe and the cone end to permit increased extension length.

11. The underwater guiding apparatus of claim 5 wherein the cone end is secured to the telescoping assembly by being bolted or welded on to the inner extension pipe.

12. The underwater guiding apparatus of claim 5 the further comprising a means for adjusting the angle of the telescoping assembly.

13. The underwater guiding apparatus of claim 12 wherein the means for adjusting the angle of the telescoping assembly is a winch.

14. The underwater guiding apparatus of claim 5 wherein one or more of the pipes of the telescoping assembly are comprised of a plurality of bars in a substantially cylindrical pattern and a friction sleeve positioned within and secured by the bars.

15. The underwater guiding apparatus of claim 14 wherein the bars are constructed containing cavities thereby enabling the pipe to function as a floatation vessel.

16. The underwater guiding apparatus of claim 13 wherein one or more of the components of the telescoping assembly further comprise integrated flotation vessels.

17. A method for guiding underwater submerged elongated structures through varying water column depths comprising the steps of:
a. positioning the underwater guiding apparatus of claim 4 in the area of the elongated structure to be guided; and
b. orienting the telescoping assembly to the desired angle and extension length.

18. The method for guiding underwater submerged elongated structures of claim 17 wherein the elongated structure is one of stems, rods, piping, tubing, hoses, cables, and lines.

19. The method for guiding underwater submerged elongated structures of claim 17 wherein the guiding is performed for the placement and installation of the elongated structures.

20. The method for guiding underwater submerged elongated structures of claim 17 further comprising the step of securing the base to a fixed or variable elevation work surface.
